(19) United States
(12) Patent Application Publication
(10) Pub. No.: US 2012/0314574 A1
(43) Pub. Date: Dec. 13, 2012

(54) METHOD AND APPARATUS FOR ENABLING CODER SELECTION AND RATE ADAPTATION FOR 3GPP FOR MEDIA STREAMS BETWEEN A MEDIA AND A MOBILE TERMINAL

(75) Inventor: Kamel M. Shaheen, King of Prussia, PA (US)

(73) Assignee: INTERDIGITAL PATENT HOLDINGS, INC., Wilmington, DE (US)

(21) Appl. No.: 13/514,479

(22) PCT Filed: Dec. 7, 2010
(86) PCT No.: PCT/US10/59271

§ 371 Date: Aug. 1, 2012

(30) Foreign Application Priority Data
Dec. 7, 2009 (US) 61267317

(51) Int. Cl. H04W 28/12

(52) U.S. Cl. 370/231

(57) ABSTRACT

A method for enabling coder selection and rate adaptation in a UMTS Terrestrial Radio Access Network (UTRAN)/enhanced UTRAN (E-UTRAN), the method comprising receiving a media stream from a server at a first data rate, transmitting a feedback signal to the server indicating conditions at the UTRAN/E-UTRAN, wherein the feedback signal includes an indication of available buffer space, roundtrip time, data packets received at the UTRAN/E-UTRAN, data packets played out, and an air link condition, and receiving the media stream at an adjusted second data rate based on the feedback signal transmitted to the server.

### CROSS REFERENCE TO RELATED APPLICATIONS

This application claims the benefit of U.S. provisional application No. 61/267,317 filed Dec. 7, 2009, the contents of which is hereby incorporated by reference herein.

### TECHNICAL FIELD

This application is related to wireless communications.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as, for example, UMTS Terrestrial Radio Access Network (UTRAN), Long Term Evolution (LTE), Worldwide Interoperability for Microwave Access (WiMax), or Wireless Local Area Network (WLAN) technology. A WTRU may access the IMS through a packet-switched (PS) domain. Through the use of IMS Centralized Services (ICS), a WTRU may additionally access IMS services via a circuit-switched (CS) domain.

A codec (COder/DECoder) is a hardware module and/or software program that is used typically to convert analogue information (such as speech) into a digital stream for transmission, and then back to analogue again at the receiving end. At the same time, codecs are generally designed to compress the information in order to minimize the amount of bandwidth or storage space used.

An example of the existing codec architecture is shown in FIG. 2. According to the existing architecture, the encoding and the decoding processes take place in the transmitting and receiving ends of a communication in a digital network. The codec is located in the User Equipment (UE) and Media Gateway (MGW), and the rate is mainly controlled by the Radio Network Controller (RNC) based on cell load.

The channel encoder or encoder/decoder encodes or decodes a data stream or signal transmission video. Streaming has become increasingly more important over the past few years. In a multimedia streaming service, there are three participants involved: a streaming user equipment, a streaming server/client and a transmission channel or an underlying network. In a real-time streaming system, due to the dynamically changing throughput characteristics of the channel, the client and the server, the streaming delivery needs to be adaptive in order to maintain a real-time playback experience for the user. The server may adapt the transmission rate to the varying throughput of the system.

In order to control the data rate for the media types used in service, an appropriate codec must be first selected. The factors contributing to the codec selection process may include any one or more of the following: network loading conditions, codecs supported by the end points, and the preference order of the codecs, and operator policies. The codec selection process may cause interruptions during the continuous playout of a multimedia stream due to the fact that the transport network has to provide throughput at the same bit rate as the rate of the encoded content. Therefore, a new technology is needed for load adaptive applications in UTRAN and enhanced UTRAN (E-UTRAN) to provide mechanisms for selecting the codec rate based on network loading conditions and operator policies.

### SUMMARY

A method for enabling coder selection and rate adaptation in a UMTS Terrestrial Radio Access Network (UTRAN)/enhanced UTRAN (E-UTRAN), (the method can be used for both uplink and downlink), the method comprising receiving a media stream from a server at a first data rate, transmitting a feedback signal to the server indicating conditions at the UTRAN/E-UTRAN, wherein the feedback signal includes an indication of available buffer space, roundtrip time, data packets received at the UTRAN/E-UTRAN, data packets played out, and an air link condition, and receiving the media stream at an adjusted second data rate based on the feedback signal transmitted to the server.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an existing codec architecture;

FIG. 3 shows an overview of an adaptive streaming session;

FIG. 4 shows a generic adaptive HTTP streaming architecture;

FIG. 5 shows a 3GPP adaptive RTCP based codec architecture;

FIG. 6 shows a 3GPP RAN based adaptive streaming session; and

FIG. 7 shows a 3GPP RAN based adaptive bi-direction streaming session.

### DETAILED DESCRIPTION

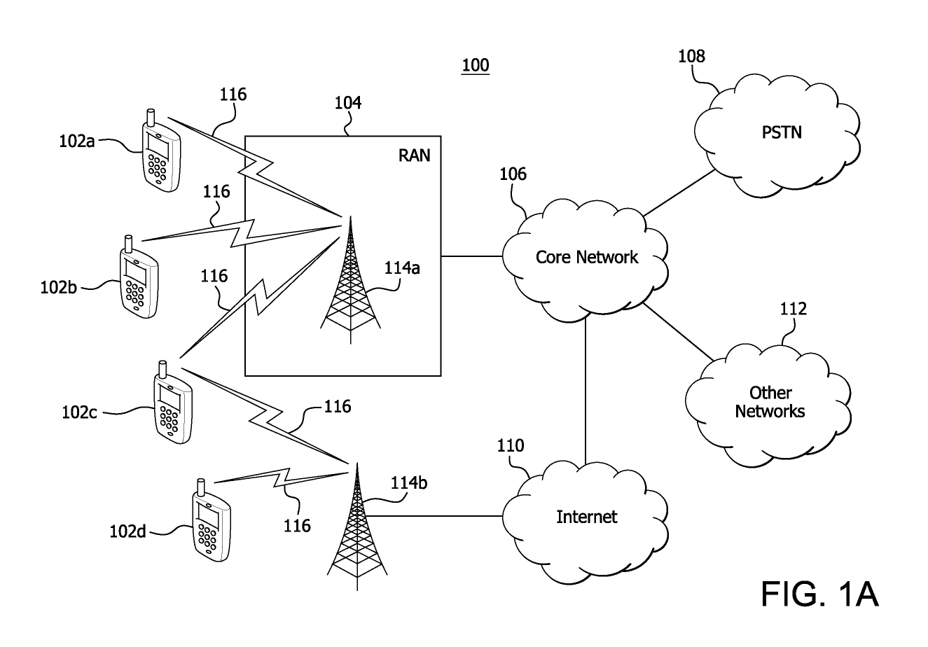

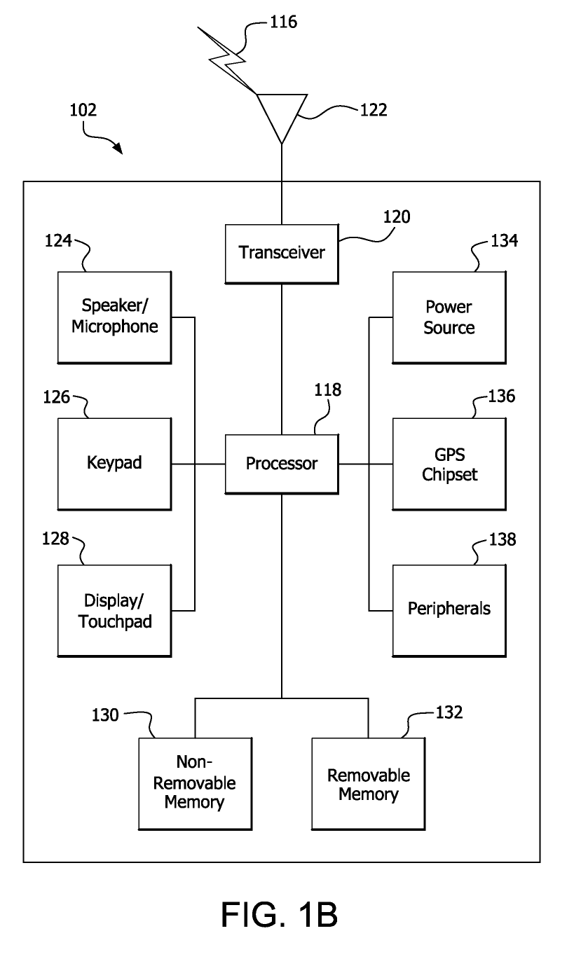

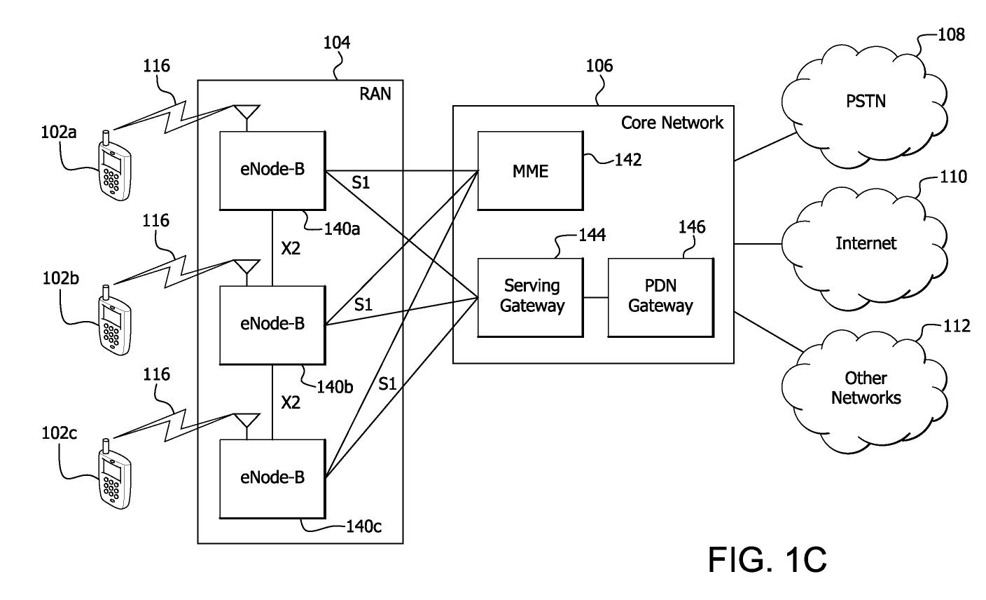

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

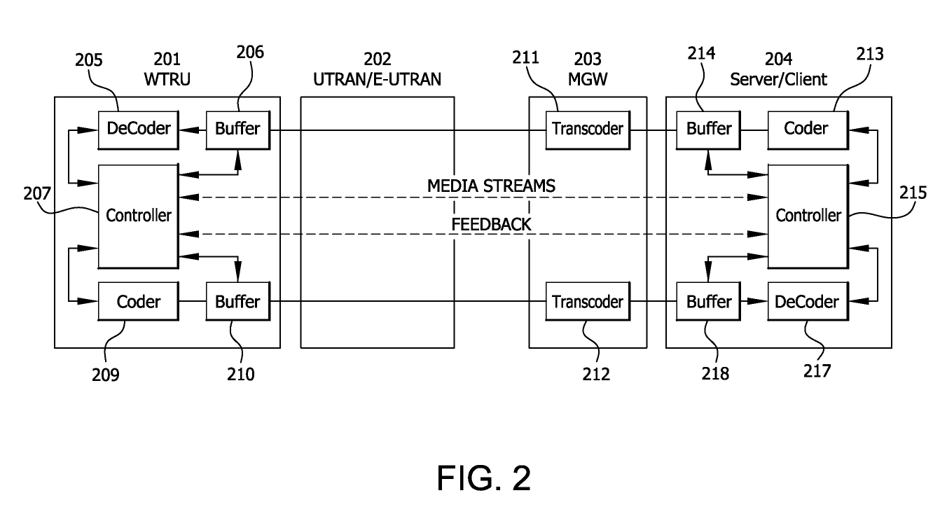

FIG. 2 shows an existing codec (COder/DECoder) architecture. In the existing architecture the server/client 204 may stream media to a WTRU 201 via a Media Gateway (MGW) 203. The server/client 204 may include a buffer 214 associated with a coder 213, a controller 215, and a buffer 218 associated with a decoder 217. The WTRU 201 may include a buffer 206 associated with a decoder 205, a controller 207, and a buffer 210 associated with a coder 209. The MGW 203 may include a transcoder 211 for a downlink channel transmission and a transcoder 212 for an uplink channel transmission.

For example, in the existing coding architecture of FIG. 2, a media stream may be transmitted from a server/client 204 to the WTRU 201 in a downlink channel. The media stream is processed in a coder 213 before being transmitted from the server/client 204 to the WTRU 201. The media stream may then be transmitted from the server/client 204 and pass through a transcoder 211 of the MGW 203 before being received by the WTRU 201. The media stream may then be received by a decoder 205 after passing through a buffer 206 of the WTRU 201. Then, a controller 207 of the WTRU 201 may determine how the received media stream is processed by the decoder 205 based on information from the buffer 206. The controller 207 may then transmit feedback to the server/client 204 based on the information received from the buffer 206. If the buffer 206 is empty, the controller 207 may signal the server/client 204 to increase the data rate. If the buffer 206 is full, the controller 207 may signal the server/client 204 to decrease the data rate.

A media stream may also be transmitted from the WTRU 201 to the server/client 204 in an uplink channel. The media stream is processed in a coder 209 before being transmitted from the WTRU 201 to the server/client 204. The media stream may then be transmitted from the WTRU 201 and pass through a transcoder 212 of the MGW 203 before being received by the server/client 204. The media stream may then be received by the server/client 204 and processed by a decoder 217 after passing through a buffer 218 of the server/client 204. Then, a controller 215 of the server/client 204 may determine how the media stream was received at the decoder 217 based on the information from the buffer 218. The controller 215 may then transmit feedback to the WTRU 201 based on the information received from the buffer 218. If the buffer 218 is empty, the controller 215 may signal the WTRU 201 to increase the data rate. If the buffer 218 is full, the controller 215 may signal the WTRU 201 to decrease the data rate.

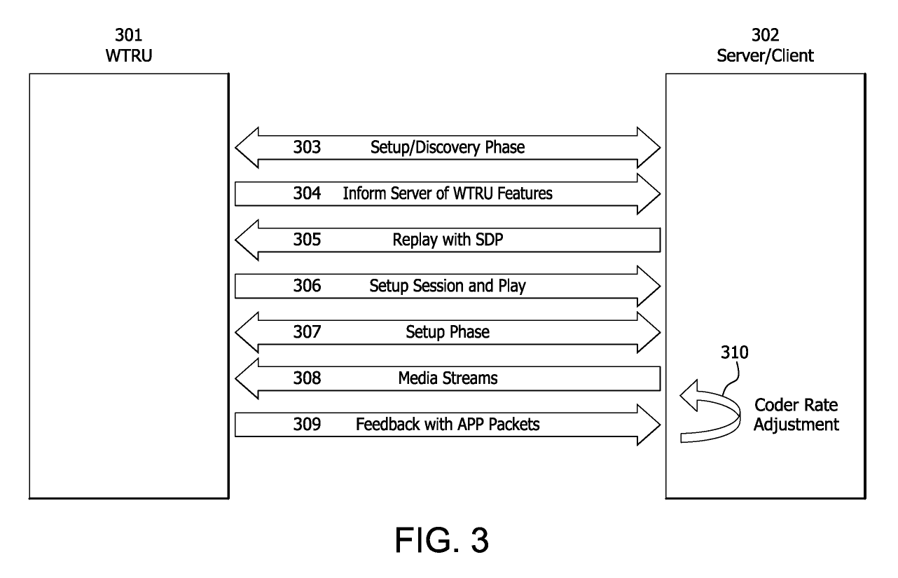

FIG. 3 shows an overview of an adaptive streaming session between a WTRU 301 and a server 302. The server/client 302 may determine the availability of the WTRU 301 in a setup/discovery phase (303) via RTCP (real-time control protocol) signaling. The WTRU 301 may transmit a message to the server/client 302 containing a profile of the WTRU's 301 features and capabilities (304). The server/client 302 may transmit a message with SDP (session description protocol) (305) to configure the WTRU 301 with accepted media and inform the WTRU 301 of the server/client 302's capabilities. The WTRU 301 may transmit a setup session and play message (306) to the server/client 302. The setup session and play message may contain information about the WTRU's 301 link QoS (quality of service), bandwidth, and maximum buffer size. The WTRU 301 and the server/client 302 may establish a setup phase (307) where the bandwidth is located and a media stream begins to flow. The server/client 302 may transmit media streams to the WTRU 301 on a downlink channel (308). The media streams are adapted to link characteristics of the WTRU 301. The WTRU 301 may then transmit feedback with application packets (309) to the server/client 302. The feedback from the WTRU 301 may contain buffer information, real time delay, packets played out, and packets received. The server/client 302 may make a coder rate adjustment (310) based on the feedback received from the WTRU 301.

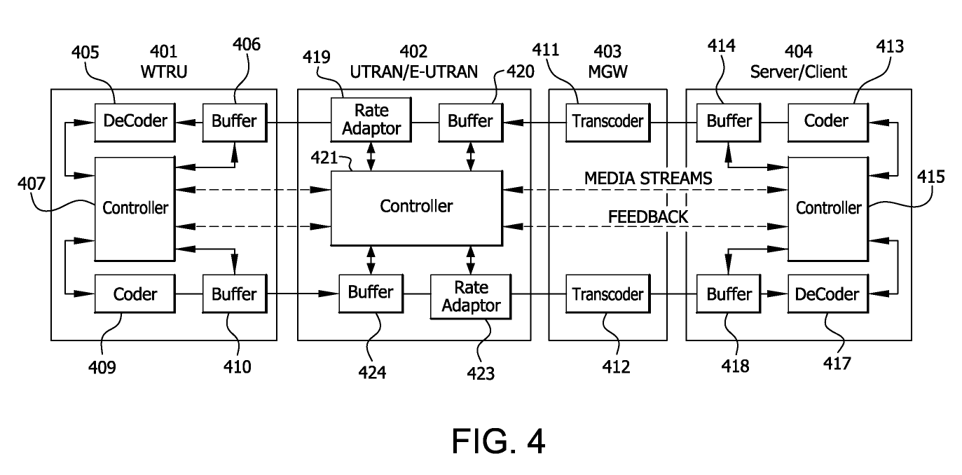

FIG. 4 shows a generic adaptive HTTP (hypertext transfer protocol) streaming architecture. An HTTP server/client 404 may stream media to a WTRU 401 via a UMTS Terrestrial Radio Access Network (UTRAN)/enhanced UTRAN (E-UTRAN) 402. The UTRAN/E-UTRAN 402 acts as a proxy between the HTTP server/client 404 and the WTRU 401. The HTTP server/client 404 may contain a buffer 414 associated with a coder 413, a controller 415, and a buffer 418 associated with a decoder 417. The UTRAN/E-UTRAN 403 may contain a buffer 420 associated with a rate adaptor 419, a controller 421, and a buffer 424 associated with a rate adaptor 423. The controller 421 of the UTRAN/E-UTRAN may have split signaling to the HTTP server/client 404 and the WTRU 401. The WTRU 401 may contain a buffer 406 associated with a decoder 405, a controller 407, and a buffer 410 associated with a coder 409. A MGW 403 may include a transcoder 411 for a downlink channel transmission and a transcoder 412 for an uplink channel transmission.

For example, in the generic adaptive HTTP streaming architecture of FIG. 4, a media stream may be transmitted from a HTTP server/client 404 to the WTRU 401 in a downlink channel. The media stream is processed by a coder 413 before being transmitted from the HTTP server/client 404 to the UTRAN/E-UTRAN 402. The media stream may then be transmitted from the HTTP server/client 404 and pass through a transcoder 411 of a MGW 403 before being received by the UTRAN/E-UTRAN 403. The media stream may then be received by a rate adaptor 419 after passing through a buffer 420 of the UTRAN/E-UTRAN 402. Then, a controller 421 of the UTRAN/E-UTRAN 402 may determine how the received media stream is processed by the rate adaptor 419 based on information from the buffer 420. The controller 421 may then transmit feedback to the HTTP server/client 404 based on the information received from the buffer 420 with respect to the air interface. If the buffer 420 is empty, the controller 421 may signal the HTTP server/client 404 to increase the data rate. If the buffer 420 is full, the controller 421 may signal the HTTP server/client 404 to decrease the data rate.

Once the controller 421 determines the proper data rate, the media stream may be processed using a decoder 405 after passing through a buffer 406 of the WTRU 401. Then, a controller 407 of the WTRU 401 may determine how the media stream is received at the decoder 405 based on information from the buffer 406. The controller 407 may then transmit feedback to the UTRAN/E-UTRAN 402 based on the information received from the buffer 406 with respect to the air interface. If buffer 406 is empty, the controller 407 may signal the UTRAN/E-UTRAN 402 to increase the data rate. If the buffer 406 is full, the controller 407 may signal the UTRAN/E-UTRAN 402 to decrease the data rate.

A media stream may also be transmitted from the WTRU 401 to the HTTP server/client 404 in an uplink channel. The media stream is processed by a coder 409 before being transmitted from the WTRU 401 to the UTRAN/E-UTRAN 402. The media stream may then be received by a rate adaptor 423 after passing through a buffer 424 of the UTRAN/E-UTRAN 402. Then, a controller 421 of the UTRAN/E-UTRAN 402 may determine how the received media stream is processed by the rate adaptor 423 based on information received from the buffer 424. The controller 421 may then transmit feedback to the WTRU 401 based on the information received from the buffer 424 with respect to the air interface. If the buffer 424 is empty, the controller 421 may signal the WTRU 401 to increase the data rate. If the buffer 424 is full, the controller 421 may signal the WTRU 401 to decrease the data rate.

Once the controller 421 determines the proper data rate, the media stream may then be transmitted from the UTRAN/E-UTRAN 402 and pass through a transcoder 412 of the MGW 403 before being received by the HTTP server/client 404. The media stream may be received by a decoder 417 after passing through a buffer 418 of the HTTP server/client 404. Then, a controller 415 of the HTTP server/client 404 may determine how the received media stream is processed by the decoder 417 based on information from the buffer 418. The controller 415 may then transmit feedback to the UTRAN/E-UTRAN 402 based on the information received from the buffer 418 with respect to the air interface. If the buffer 418 is empty, the controller 415 may signal the UTRAN/E-UTRAN 402 to increase the data rate. If the buffer 418 is full, the controller 415 may signal the UTRAN/E-UTRAN 402 to decrease the data rate.

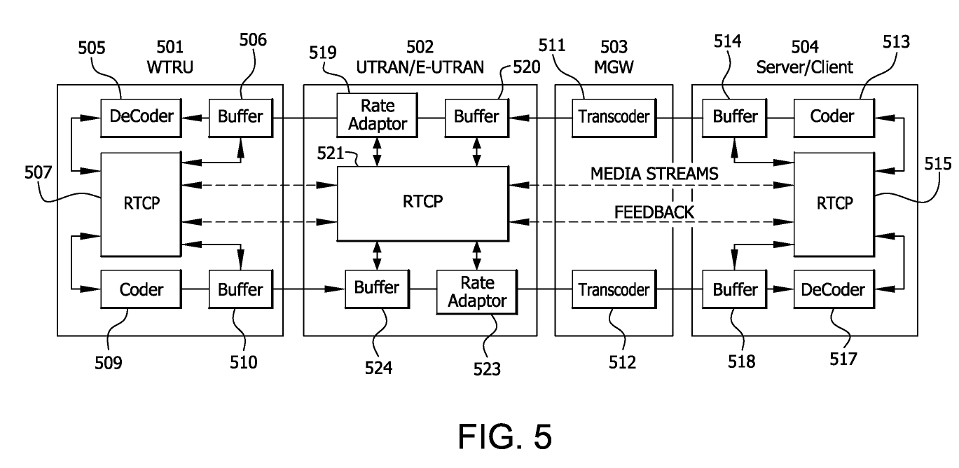

FIG. 5 shows a 3GPP adaptive RTCP based codec architecture. A server/client 504 may stream media to a WTRU 501 via a UTRAN/E-UTRAN 502. The UTRAN/E-UTRAN 502 acts as a proxy between the server/client 504 and the WTRU 501. The server/client 504 may contain a buffer 514 associated with a coder 513, a RTCP (Real-Time Transport Control Protocol) process unit 515, and a buffer 518 associated with a decoder 517. The UTRAN/E-UTRAN 503 may contain a buffer 520 associated with a rate adaptor 519, an RTCP process unit 521, and a buffer 524 associated with a rate adaptor 523. The RTCP process unit 521 of the UTRAN/E-UTRAN may have split signaling to the server/client 504 and the WTRU 501. The WTRU 501 may contain a buffer 506 associated with a decoder 505, an RTCP process unit 507, and a buffer 510 associated with a coder 509. A MGW 503 may include a transcoder 511 for a downlink channel transmission and a transcoder 512 for an uplink channel transmission.

For example, in the 3GPP adaptive RTCP based codec architecture of FIG. 5, a media stream may be transmitted from a server/client 504 to the WTRU 501 in a downlink channel. The media stream is process in a coder 513 before being transmitted from the server/client 504 to the WTRU 501. The media stream may then be transmitted from the server/client 504 and pass through a transcoder 511 of a MGW 503 before being received by the UTRAN/E-UTRAN 502. The media stream may then be received by a rate adaptor 519 after passing through a buffer 520 of the UTRAN/E-UTRAN 502. Then, an RTCP process unit 521 of the UTRAN/E-UTRAN 502 may determine how the received media stream is processed by the rate adaptor 519 based on information from the buffer 520. The RTCP process unit 521 may then transmit feedback to the server/client 504 based on the information received from the buffer 520 with respect to the air interface. If the buffer 520 is empty, the RTCP process unit 521 may signal the server/client 504 to increase the data rate. If the buffer 520 is full, the RTCP process unit 521 may signal the server/client 504 to decrease the data rate.

Once the RTCP process unit 521 determines the proper data rate, the media stream may then be processed using a decoder 505 after passing through a buffer 506 of the WTRU 501. A RTCP process unit 507 of the WTRU 501 may determine how the media stream is received at the decoder 505 based on information from the buffer 506. The RTCP process unit 507 may then transmit feedback to the UTRAN/E-UTRAN 502 based on the information received from the buffer 506 with respect to the air interface. If buffer 506 is empty, the RTCP process unit 507 may signal the UTRAN/E-UTRAN 502 to increase the data rate. If the buffer 506 is full, the RTCP process unit 507 may signal the UTRAN/E-UTRAN 502 to decrease the data rate.

A media stream may also be transmitted from a WTRU 501 to the server/client 504 in an uplink channel. The media stream is then processed by the coder 509 in the WTRU 401 before transmission. The media stream may be received by a rate adaptor 523 after passing through a buffer 524 of the UTRAN/E-UTRAN 502. Then, an RTCP process unit 521 of the UTRAN/E-UTRAN 502 may determine how the received media stream is processed by the rate adaptor 523 based on information received from the buffer 524. The RTCP process unit 521 may then transmit feedback to the WTRU 501 based on the information received from the buffer 524 with respect to the air interface. If the buffer 524 is empty, the RTCP process unit 521 may signal the WTRU 501 to increase the data rate. If the buffer 524 is full, the RTCP process unit 521 may signal the WTRU 501 to decrease the data rate.

Once the RTCP process unit 521 determines the proper data rate, the media stream may be transmitted from the UTRAN/E-UTRAN 502 and pass through a transcoder 512 of the MGW 503 before being received by the server/client 504. The media stream may then be received by a decoder 517 after passing through a buffer 518 of the server/client 504. Then, an RTCP process unit 515 of the server/client 504 may determine how the received media stream is processed by the decoder 517 based on information from the buffer 518. The RTCP process unit 515 may then transmit feedback to the UTRAN/E-UTRAN 502 based on the information received from the buffer 518 with respect to the air interface. If the buffer 518 is empty, the RTCP process unit 515 may signal the UTRAN/E-UTRAN 502 to increase the data rate. If the buffer 518 is full, the RTCP process unit 515 may signal the UTRAN/E-UTRAN 502 to decrease the data rate.

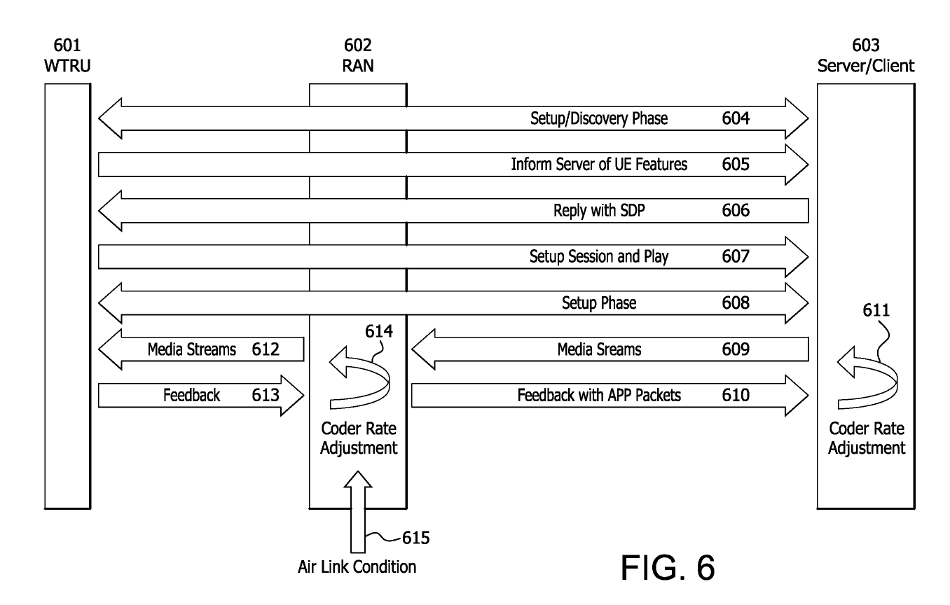

FIG. 6 shows a 3GPP RAN (radio access network) based adaptive streaming session between a WTRU 601 and a server/client 603 with a RAN 602 acting as a proxy. The server/client 603 may determine the availability of the WTRU 601 in a setup/discovery phase (604) via RTCP signaling. The WTRU 601 may transmit a message to the server/client 603 containing a profile of the WTRU's 601 features and capabilities (605). The server/client 603 may transmit a message with SDP (606) to configure the WTRU 601 with accepted media and inform the WTRU 601 of the server/client 603's capabilities. The WTRU 601 may transmit a setup session and play message (607) to the server/client 603. The setup session and play message may contain information about the WTRU's 601 link QoS, bandwidth, and maximum buffer size. The WTRU 601 and the server/client 603 may establish a setup phase (608) where the bandwidth is located and a media stream begins to flow.

The server/client 603 may transmit media streams (609) to the RAN 602 on a downlink channel. The media streams are adapted to link characteristics of the WTRU 601. The RAN 602 may then transmit feedback with application packets (610) to the server/client 603. The feedback from the RAN 602 may contain buffer information, round trip time, packets played out, packets received, and air link condition 615. The server/client 603 may make a coder rate adjustment (611) based on the feedback received from the RAN 602. The RAN 602 may also transmit media streams (612) to the WTRU 601 on the downlink channel. The media streams are adapted to link characteristics of the WTRU 601. The WTRU 601 may then transmit feedback application packets (613) to the RAN 602. The feedback from WTRU 601 may contain buffer information, round trip time, packets played out, and packets received. The RAN 602 may make a coder rate adjustment (614) based on the feedback received from the WTRU 601.

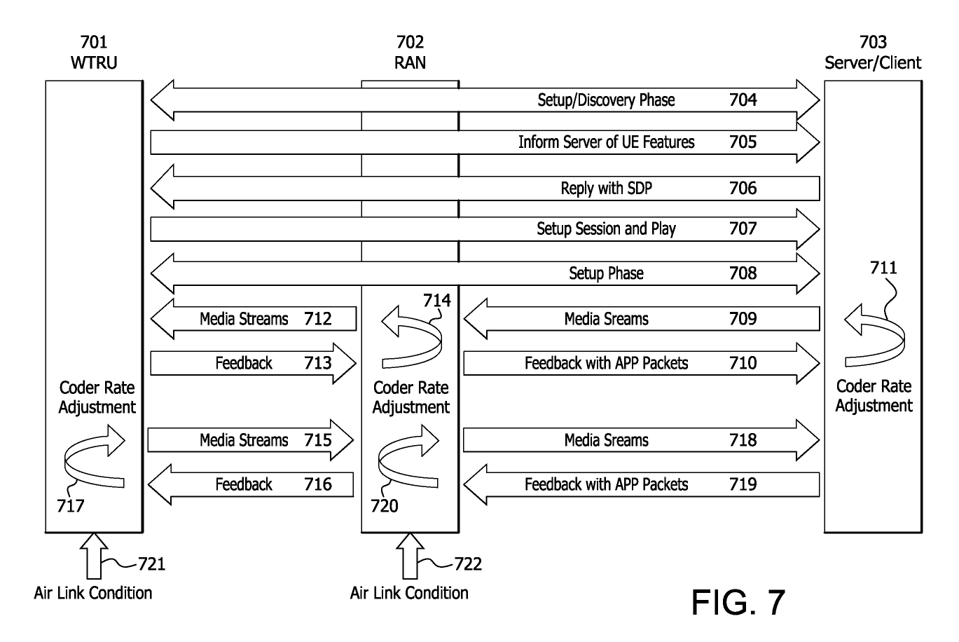

FIG. 7 shows a 3GPP RAN based adaptive bi-directional streaming session between a WTRU 701 and a server/client 703 with a RAN 702 acting as a proxy. The server/client 703 may determine the availability of the WTRU 701 in a setup/discovery phase (704) via RTCP signaling. The WTRU 701 may transmit a message to the server/client 703 containing a profile of the WTRU's 701 features and capabilities (705). The server/client 703 may transmit a message with SDP (706) to configure the WTRU 701 with accepted media and inform the WTRU 701 of the server/client 703's capabilities. The WTRU 701 may transmit a setup session and play message (707) to the server/client 703. The setup session and play message may contain information about the WTRU's 701 link QoS, bandwidth, and maximum buffer size. The WTRU 701 and the server/client 703 may establish a setup phase (708) where the bandwidth is located and a media stream begins to flow.

The server/client 703 may transmit media streams (709) to the RAN 702 on a downlink channel. The media streams are adapted to link characteristics of the WTRU 701. The RAN 702 may then transmit feedback with application packets (710) to the server/client 703. The feedback from the RAN 702 may contain buffer information, round trip time, packets played out, packets received, and air link condition 722. The server/client 703 may make a coder rate adjustment (711) based on the feedback received from the RAN 702. The RAN 702 may also transmit media streams (712) to the WTRU 701 on the downlink channel. The media streams are adapted to link characteristics of the WTRU 701. The WTRU 701 may then transmit feedback application packets (713) to the RAN 702. The feedback from WTRU 701 may contain buffer information, round trip time, packets played out, packets received, and air link condition 721. The RAN 702 may make a coder rate adjustment (714) based on the feedback received from the WTRU 701.

The WTRU 701 may transmit media streams (715) to the RAN 702 on an uplink channel. The media streams are adapted to link characteristics of the server/client 703. The RAN 702 may then transmit feedback with application packets (716) to the WTRU 701. The feedback from the RAN 702 may contain buffer information, round trip time, packets played out, and packets received. The WTRU 701 may make a coder rate adjustment (717) base on the feedback received from the RAN 702. The RAN 702 may also transmit media streams (718) to the server/client 703 on the uplink channel. The media streams are adapted to link characteristics of the server/client 703. The server/client 703 may then transmit feedback application packets (719) to the RAN 702. The feedback from the server/client 703 may contain buffer information, round trip time, packets played out, packets received, and air link condition 722. The RAN 702 may make a coder rate adjustment (720) based on the feedback received from the server/client 703.

### Embodiments

1. A method for enabling coder selection and rate adaptation in a UMTS Terrestrial Radio Access Network (UTRAN)/enhanced UTRAN (E-UTRAN), the method comprising:

receiving a media stream from a server at a first data rate.

2. The method as in embodiment 1, further comprising:

transmitting a feedback signal to the server indicating conditions at the

UTRAN/E-UTRAN, wherein the feedback signal includes an indication of available buffer space in the UTRAN/E-UTRAN, roundtrip time between the server and the UTRAN/E-UTRAN, data packets received at the UTRAN/E-UTRAN, data packets streamed at the UTRAN/E-UTRAN, and an air link condition; and

receiving the media stream at an adjusted second data rate based on the

feedback signal transmitted to the server.

3. The method as in embodiment 2, further comprising:

transmitting the media stream to a wireless transmit/receive unit (WTRU) at the second data rate.

4. The method as in any one of embodiments 1-3, further comprising:

receiving a feedback signal from the WTRU indicating conditions at the

WTRU, wherein in the feedback signal includes an indication of available buffer space in the WTRU, roundtrip time between the WTRU and the UTRAN/E-UTRAN, data packets received at the WTRU, and data packets streamed at the WTRU; and

adjusting the second data rate based on the feedback signal received from

### the WTRU.

5. The method as in any one of embodiments 2-4 wherein the second data rate is increased on a condition that a buffer of the WTRU is empty.

6. The method as in any one of embodiments 2-4 wherein the second data rate is decreased on a condition that a buffer of the WTRU is full.

7. The method as in any one of embodiments 2-4 wherein the second data rate is increased on a condition that a buffer of the UTRAN/E-UTRAN is empty.

8. The method as in anyone of embodiments 2-4 the second data rate is decreased on a condition that a buffer of the UTRAN/E-UTRAN is full.

9. The method as in any one of embodiments 1-8 wherein the UTRAN/E-UTRAN is used in HTTP (hypertext transfer protocol).

10. The method as in any one of embodiments 1-8 wherein the UTRAN/E-UTRAN is used in 3GPP.

11. A method for enabling coder selection and rate adaptation in a UMTS Terrestrial Radio Access Network (UTRAN)/enhanced UTRAN (E-UTRAN), the method comprising:

receiving a media stream from a wireless transmit/receive unit (WTRU).

12. The method as in embodiment 11, further comprising:

transmitting a feedback signal to the WTRU indicating conditions at the

UTRAN/E-UTRAN, wherein the feedback signal includes an indication of available buffer space in the UTRAN/E-UTRAN, roundtrip time between the WTRU and the UTRAN/E-UTRAN, data packets received at the UTRAN/E-UTRAN, data packets streamed at the UTRAN/E-UTRAN, and an air link condition; and

receiving the media stream at an adjusted second data rate based on the

feedback signal transmitted to the WTRU.

13. The method as in embodiment 12, further comprising:

transmitting the media stream to a server at the second data rate.

14. The method as in any one of embodiments 11-13, further comprising:

receiving a feedback signal from the server indicating conditions at the

server, wherein in the feedback signal includes an indication of available buffer space in the server, roundtrip time between the server and the UTRAN/E-UTRAN, data packets received at the server, and data packets streamed at the server; and

adjusting the second data rate based on the feedback signal received from

the server.

15. The method as in any one of embodiments 12-14 wherein the second data rate is increased on a condition that a buffer of the WTRU is empty.

16. The method as in any one of embodiments 12-14 wherein the second data rate is decreased on a condition that a buffer of the WTRU is full.

17. The method as in any one of embodiments 12-14 wherein the second data rate is increased on a condition that a buffer of the UTRAN/E-UTRAN is empty.

18. The method as in any one of embodiments 12-14 wherein the second data rate is decreased on a condition that a buffer of the UTRAN/E-UTRAN is full.

19. The method as in any one of embodiments 11-18 wherein the UTRAN/E-UTRAN is used in HTTP (hypertext transfer protocol).

20. The method as in any one of embodiments 11-18 wherein the UTRAN/E-UTRAN is used in 3GPP.

21. A UMTS Terrestrial Radio Access Network (UTRAN)/enhanced UTRAN (E-UTRAN) for enabling coder selection and rate adaption comprising:

a transmitter configured to transmit a media stream to a wireless transmit/receive unit (WTRU).

22. The apparatus as in embodiment 21, further comprising:

a receiver configured to receive a feedback signal from the WTRU.

23. The apparatus as in any one of embodiments 21-22, further comprising:

a rate adaptor configured to adjust a data rate of a media stream based on

the feedback signal received from the WTRU; and

a controller configured to process the feedback signal received from the

### WTRU.

24. The apparatus as in embodiment 23 wherein the transmitter is further configured to transmit a feedback signal to a server, the receiver is further configured to receive a media stream from a server, and the controller is further configured to process the media stream received from the server.

25. A base station for enabling coder selection and rate adaption comprising:

a receiver configured to receive a media stream from a WTRU.

26. The base station as in embodiment 25 further comprising:

a transmitter configured to transmit a feedback signal to the WTRU,

wherein the feedback includes available buffer space, roundtrip time, data packets received, data packets played out, and an air link condition; and

a controller configured to adjust a data rate of the media stream based

on the amount of available space in a buffer of the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for enabling coder selection and rate adaptation in a Universal Mobile Telecommunications System (UMTS) Terrestrial Radio Access Network (UTRAN), the method comprising:
receiving a media stream from a server at a first data rate;
transmitting a feedback signal to the server, wherein the feedback signal includes an indication of available buffer space in the UTRAN, roundtrip time between the server and the UTRAN, data packets received at the UTRAN, data packets streamed at the UTRAN, and an air link condition;
receiving the media stream at an adjusted second data rate based on the feedback signal transmitted to the server;
transmitting the media stream to a wireless transmit/receive unit (WTRU) at the second data rate;
receiving a feedback signal from the WTRU, wherein in the feedback signal includes an indication of available buffer space in the WTRU, roundtrip time between the WTRU and the UTRAN, data packets received at the WTRU, and data packets streamed at the WTRU; and
adjusting the second data rate based on the feedback signal received from the WTRU.

2. (canceled)

3. The method of claim 1 wherein the second data rate is increased on a condition that a buffer of the WTRU is empty.

4. The method of claim 1 wherein the second data rate is decreased on a condition that a buffer of the WTRU is full.

5. The method of claim 1 wherein the second data rate is increased on a condition that a buffer of the UTRAN is empty.

6. The method of claim 1 wherein the second data rate is decreased on a condition that a buffer of the UTRAN is full.

7. The method of claim 1 wherein the UTRAN is used in HTTP (hypertext transfer protocol).

8. The method of claim 1 wherein the UTRAN is used in 3GPP.

9. A method for enabling coder selection and rate adaptation in a Universal Mobile Telecommunications System (UMTS) Terrestrial Radio Access Network (UTRAN), the method comprising:
receiving a media stream from a wireless transmit/receive unit (WTRU);
transmitting a feedback signal to the WTRU, wherein the feedback signal includes an indication of available buffer space in the UTRAN, roundtrip time between the WTRU and the UTRAN, data packets received at the UTRAN, data packets streamed at the UTRAN, and an air link condition;
receiving the media stream at an adjusted second data rate based on the feedback signal transmitted to the WTRU;
transmitting the media stream to a server at the second data rate;
receiving a feedback signal from the server, wherein in the feedback signal includes an indication of available buffer space in the server, roundtrip time between the server and the UTRAN, data packets received at the server, and data packets streamed at the server; and
adjusting the second data rate based on the feedback signal received from the server.

10. (canceled)

11. The method of claim of claim 9 wherein the second data rate is increased on a condition that a buffer of the WTRU is empty.

12. The method of claim 9 wherein the second data rate is decreased on a condition that a buffer of the WTRU is full.

13. The method of claim 9 wherein the second data rate is increased on a condition that a buffer of the UTRAN is empty.

14. The method of claim 9 wherein the second data rate is decreased on a condition that a buffer of the UTRAN is full.

15. The method of claim 9 wherein the UTRAN is used in HTTP (hypertext transfer protocol).

16. The method of claim 9 wherein the UTRAN is used in 3GPP.

17. A Universal Mobile Communications System (UMTS) Terrestrial Radio Access Network, UTRAN (UTRAN) for enabling coder selection and rate adaption comprising:
a transmitter configured to transmit a media stream to a wireless transmit/receive unit, WTRU;
a receiver configured to receive a feedback signal from the WTRU;
a rate adaptor configured to adjust a data rate of a media stream based on the feedback signal received from the WTRU; and
a controller configured to process the feedback signal received from the WTRU;
wherein the transmitter is further configured to transmit a feedback signal to a server, the receiver is further configured to receive a media stream from a server, and the controller is further configured to process the media stream received from the server.

18.-19. (canceled)

20. The method of claim 1 wherein the UTRAN is an enhanced UTRAN (E-UTRAN).

21. The method of claim 9 wherein the UTRAN is an enhanced UTRAN (E-UTRAN).

22. The method of claim 17 wherein the UTRAN is an enhanced UTRAN (E-UTRAN).
